(19) United States
(12) Patent Application Publication
(10) Pub. No.: US 2026/0051078 A1
(43) Pub. Date: Feb. 19, 2026

(54) METHOD OF CAMERA CALIBRATION USING ACTIVE LASER PROJECTION

(71) Applicant: National Taipei University of Technology, Taipei (TW)

(72) Inventors: Huei-Yung Lin, Taipei (TW); Shih-Han Wei, Taipei (TW)

(21) Appl. No.: 18/922,766

(22) Filed: Oct. 22, 2024

(30) Foreign Application Priority Data
Aug. 16, 2024 (TW) 113131003

(51) Int. Cl. G06T 7/80; H04N 23/56

(52) U.S. Cl. CPC G06T 7/80; H04N 23/56; G06T 2207/30244

(57) ABSTRACT

The present invention provides a method of camera calibration using active laser projection, which includes: providing a camera calibration system, which includes a camera and a plurality of laser emitters; operating the camera calibration system to cause the laser emitters to project corresponding plurality of laser light spots on two planes; obtaining image coordinates of the laser light spots through image processing; and calculating three-dimensional coordinates of the laser light spots using a pinhole imaging principle according to known intrinsic parameters of the camera and the image coordinates of the laser light spots to obtain multiple degrees of freedom of the camera accordingly.

### CROSS-REFERENCE TO RELATED APPLICATIONS

This application claims priority to Taiwan Application Serial Number 113131003, filed Aug. 16, 2024, which is herein incorporated by reference in its entirety.

### BACKGROUND

### Technical Field

The present invention relates to a method of camera calibration, and in particular to a method of camera calibration using active laser projection.

### Related Art

Generally, in order to obtain correct surrounding perception or depth information using imaging methods, camera calibration is an indispensable procedure, and its purpose is to obtain parameters including camera position and attitude. Most methods of camera calibration in the prior art require the use of additional calibration tools (e.g., a calibration board), but are not suitable for application scenarios that require frequent camera calibration, such as outdoor scenes and dynamic environments. In addition, some methods of camera calibration in the prior art even require other auxiliary measurement tools such as expensive equipment of LiDAR, IMU, etc., or multiple cameras are used to perform multi-view calculations, which is relatively inconvenient to use.

Therefore, how to solve the above problems is an important issue that the industry must face and solve at present.

### SUMMARY

In view of this, the purpose of the present invention is to obtain multidimensional information by projecting on two planes using laser emitters (without ranging function) and (at least one) camera. Furthermore, six or more laser emitters are used for projection on the two planes with known camera parameters (a focal length, a pixel size, etc.), a positional relationship between the camera and the laser emitters, and coordinate positions of the laser light spots on an image, to calculate multiple degrees of freedom of the camera.

The technical means of the invention of the present disclosure is a method of camera calibration using active laser projection, which does not require the use of a calibration board and does not require other auxiliary measurement tools such as LiDAR, IMU, etc., nor does it require multi-viewing calculations through multiple cameras. Compared with existing methods of camera calibration, the technology of the invention of the present disclosure has advantages of low cost, easy to use, high environmental adaptability, and high accuracy. It can be widely used in camera calibration of vehicle imaging systems, mobile robots, and outdoor monitoring equipment.

Based on the above, one aspect of the present disclosure provides a method of camera calibration using active laser projection, including:
providing a camera calibration system, which includes a camera and a plurality of laser emitters;
operating the camera calibration system to cause the laser emitters to project corresponding plurality of laser light spots on two planes;
obtaining image coordinates of the laser light spots through image processing;
and calculating three-dimensional coordinates of the laser light spots using a pinhole imaging principle according to known intrinsic parameters of the camera and the image coordinates of the laser light spots to obtain multiple degrees of freedom of the camera accordingly.

According to one or more embodiments of the present disclosure, when X and Y coordinates of any laser light spot in a camera coordinate system are known, a Z coordinate is calculated through following formula (1) of a pinhole imaging and similar triangle principle,

$$Z = \frac{Xf}{( u - {c}_{x} ) d} = \frac{Yf}{( v - {c}_{y} ) d} \qquad formula ( 1 )$$

In which (X, Y, Z) are coordinates of any laser light spot projected on the two planes, and (u, v) are coordinates of the laser light spot on an image plane, and f is a focal length, and d is a pixel size, and (cₓ, c_{y}) are coordinates of an origin of the image plane in a pixel coordinate system, in which the known intrinsic parameters of the camera are the focal length f and image center coordinates (cₓ, c_{y}).

According to one or more embodiments of the present disclosure, the method further includes: calculating an equation of the two planes using the three-dimensional coordinates of the laser light spots.

According to one or more embodiments of the present disclosure, the method further includes: obtaining three mutually perpendicular vectors using normal vectors of the two planes.

According to one or more embodiments of the present disclosure, the method further includes: calculating roll, yaw, pitch and a camera height from a ground using the three mutually perpendicular vectors.

According to one or more embodiments of the present disclosure, it is assumed that a plane equation is following formula (2), and there are n points in total on the plane, and n laser light spots (Xᵢ, Yᵢ,Zᵢ) are put into the following formula (2) and write it in matrix form to obtain following formula (3), wherein i=1, 2, 3, . . . n, and then a least squares method of following formula (4) is used to solve the equation of the two planes,

$$ax + by + cz = 1 \qquad formula ( 2 )$$

$$[ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ] [ \begin{matrix}a \\ b \\ c\end{matrix} ] = [ \begin{matrix}1 \\ 1 \\ ⋮ \\ 1\end{matrix} ] , n \geq 3 \qquad formula ( 3 )$$

$$[ \begin{matrix}a \\ b \\ c\end{matrix} ] = {{( {[ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ]}^{T} [ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ] )}^{- 1} [ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ]}^{T} [ \begin{matrix}1 \\ 1 \\ ⋮ \\ 1\end{matrix} ] . \qquad formula ( 4 )$$

### BRIEF DESCRIPTION OF THE DRAWINGS

FIG. 1 is a flow chart of a method of camera calibration using active laser projection in an embodiment of the present invention.

FIG. 2 is a schematic diagram of usage status of a camera calibration system using active laser projection in an embodiment of the present invention.

FIG. 3 is a schematic diagram of a camera calibration system using active laser projection in an embodiment of the present invention.

### DETAILED DESCRIPTION OF THE EMBODIMENTS

The following disclosure provides different embodiments or examples to achieve different features of the provided subject matters. The specific examples of components and arrangements described below are for simplifying the present disclosure and are not intended to be limiting; the size and shape of the components are not limited by the disclosed range or numerical values, but may depend on the process conditions of the components or the required characteristics. For example, cross-sectional views are used to describe technical features of the present invention, and these cross-sectional views are schematic diagrams of idealized embodiments. Therefore, variations in the shape shown in the figures due to manufacturing processes and/or tolerances are to be expected and should not be limited thereby.

Furthermore, spatially relative terms, such as “below”, “beneath”, “lower”, “over” and “higher”, etc., are used to easily describe the relationship between elements or features depicted in the diagrams; in addition, spatially relative terms include not only orientations depicted in diagrams, but also different orientations in which the components are used or operated.

First of all, it should be noted that in order to achieve the goals of cost reduction, ease of use, high environmental adaptability, and high accuracy, the present invention provides a method of camera calibration that can be widely used in vehicle-mounted imaging systems, mobile robots, and outdoor monitoring equipment, which is the so-called method of camera calibration using active laser projection. The method of camera calibration using active laser projection described in the following embodiments of the present invention is to project a plurality of laser beams onto a plane in space (e.g., a wall, a floor) to obtain imaging positions of the laser light spots on an image, and then to calculate extrinsic parameters of the camera including multiple degrees of freedom such as position and attitude through intrinsic parameters of the camera and a perspective projection model. The technical content of the present invention will be further described in detail below with reference to drawings and embodiments.

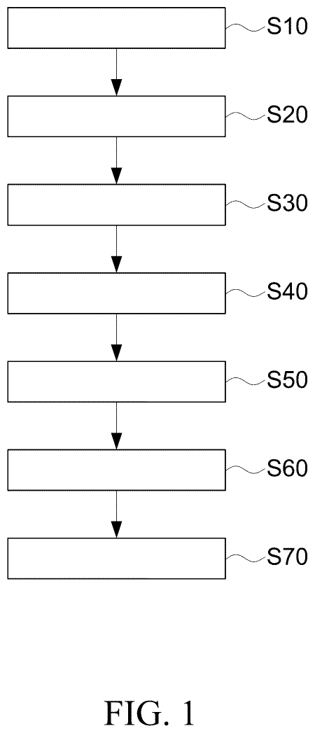

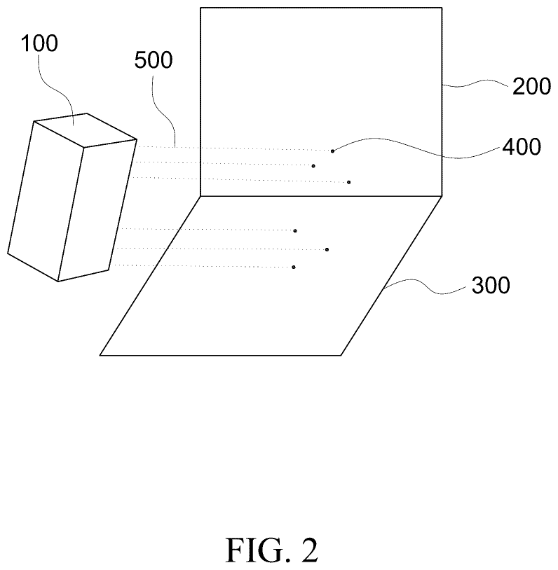

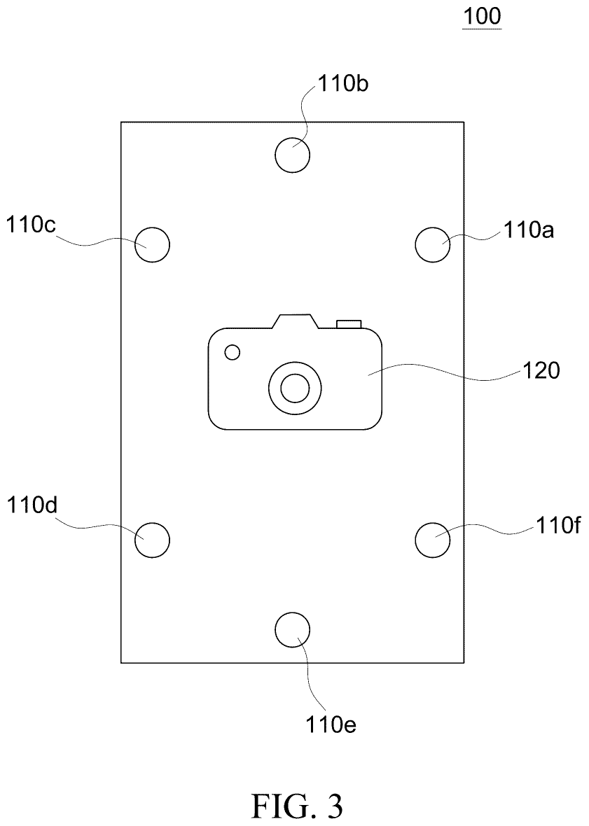

First, please refer to FIGS. 1 to 3. FIG. 1 is a flow chart of a method of camera calibration using active laser projection in an embodiment of the present invention. FIG. 2 is a schematic diagram of usage status of a camera calibration system using active laser projection in an embodiment of the present invention. FIG. 3 is a schematic diagram of a camera calibration system using active laser projection in an embodiment of the present invention. As shown in FIG. 1, in an embodiment of the present invention, a method of camera calibration using active laser projection includes steps S10, S20, S30, S40, S50, S60 and S70. As shown in FIG. 3, the camera calibration system 100 using active laser projection mainly includes a camera 120 and a plurality of laser emitters 110a, 110b, 110c, 110d, 110e, and 110f. It should be noted that in one embodiment of the present invention, the camera 120 and the laser emitters 110a, 110b, 110c, 110d, 110e, and 110f are configured in a housing, and the laser emitters 110a, 110b, 110c, 110d, 110e, and 110f are respectively arranged at appropriate distances around the camera 120.

In step S10, the laser emitters 110a, 110b, 110c, 110d, 110e, and 110f are turned on.

In step S20, it is ensured that the six laser lights are respectively illuminated on two planes and one of the planes is a ground. In an embodiment of the present invention, the two planes are a wall 200 and a ground 300, respectively. As shown in FIG. 2, when the laser emitters 110a, 110b, 110c, 110d, 110e, and 110f are turned on, the laser beams 500 are projected on the wall 200 and the ground 300 to form a plurality of laser light spots 400. In the embodiment of FIG. 2, the six laser emitters 110a, 110b, 110c, 110d, 110e, and 110f form three laser light spots 400 on the wall 200 and three laser light spots 400 on the ground 300.

In step S30, image coordinates of the laser light spots are obtained through image processing. In one embodiment of the present invention, the image is converted into a color space, and a laser color is filtered out, and a contour is then found to find positions of the laser light spots. In addition, in one embodiment of the present invention, an image processing computing device is used to execute an image processing program. In addition, in one embodiment of the present invention, the camera is connected to a computer or another embedded device to execute an image transmission program.

In step S40, three-dimensional coordinates of the laser light spots are calculated using a pinhole imaging principle through known intrinsic parameters of the camera and the image coordinates obtained in the previous step. In one embodiment of the present invention, when the coordinates of the laser light spots in a camera coordinate system are known, for example, when X and Y are known, it only needs to calculate a Z coordinate through following formula (1) of a pinhole imaging and similar triangle principle,

$$Z = \frac{Xf}{( u - {c}_{x} ) d} = \frac{Yf}{( v - {c}_{y} ) d} \qquad formula ( 1 )$$

Among them, (X, Y, Z) are coordinates of any laser light spot projected on the two planes (e.g., the floor, the wall), and (u, v) are coordinates of the laser light spot on an image plane, and f is a focal length, and d is a pixel size, and (cₓ, c_{y}) are coordinates of an origin of the image plane in a pixel coordinate system. In one embodiment of the present invention, the known internal parameters of the camera are the focal length and image center coordinates, that is the above-mentioned f and (cₓ, c_{y}).

In step S50, an equation of the two planes is calculated using the three-dimensional coordinates of the laser light spots. In one embodiment of the present invention, it is assumed that a plane equation is following formula (2), and there are n points in total on the plane, and n laser light spots (Xᵢ, Yᵢ,Zᵢ) are put into the following formula (2) and write it in matrix form to obtain following formula (3), where i=1, 2, 3, . . . n. Next, in one embodiment of the present invention, a least squares method of following formula (4) is used to solve,

$$ax + by + cz = 1 \qquad formula ( 2 )$$

$$[ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ] [ \begin{matrix}a \\ b \\ c\end{matrix} ] = [ \begin{matrix}1 \\ 1 \\ ⋮ \\ 1\end{matrix} ] , n \geq 3 \qquad formula ( 3 )$$

$$[ \begin{matrix}a \\ b \\ c\end{matrix} ] = {{( {[ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ]}^{T} [ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ] )}^{- 1} [ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ]}^{T} [ \begin{matrix}1 \\ 1 \\ ⋮ \\ 1\end{matrix} ] . \qquad formula ( 4 )$$

In step S60, three mutually perpendicular vectors are obtained using normal vectors of the two space planes. In one embodiment of the present invention, a calculated coefficient of the plane equation is a normal vector of the space plane, and normal vectors of the two planes (e.g., the ground and the wall) are calculated, and their unit vectors are taken, which are called n_{w} and n_{g}, and a third normal vector can be obtained by taking an outer product of the aforementioned two normal vectors through following formula (5), and finally a set of mutually perpendicular unit vectors is obtained,

N_{E}=N_{G}×n_{w} formula (5).

In step S70, the three mutually perpendicular vectors are used to calculate roll, yaw, and pitch of the camera and a camera height H from the ground. In one embodiment of the present invention, the matrix [N_{E} N_{G} n_{w}] formed by the three vectors obtained above is used. Because it is necessary to calculate a rotation angle of the camera, its inverse matrix [N_{E} N_{G} n_{w}]⁻¹=R is calculated, and it can also be split into following formula (6),

$$R = {R}_{Z} {R}_{Y} {R}_{X} = [ \begin{matrix}cos α & - sin α & 0 \\ sin α & cos α & 0 \\ 0 & 0 & 1\end{matrix} ] [ \begin{matrix}cos β & 0 & sin β \\ 0 & 1 & 0 \\ - sin β & 0 & cos β\end{matrix} ] [ \begin{matrix}1 & 0 & 0 \\ 0 & cos γ & - sin γ \\ 0 & sin γ & cos γ\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad formula ( 6 )$$

Among them, R_{z}, Rₓ, R_{y} respectively represent rotation matrices around Z, X, Y axes, and α, β, γ respectively represent their respective rotation angles, which is also the three-axis information (roll, yaw, and pitch) we want to get.

Next, in one embodiment of the present invention, the above three rotation angles α, β, γ can be solved according to following formula (7),

$$\{ \begin{matrix}α = {tan}_{2}^{- 1} ( {r}_{21} , {r}_{11} ) \\ β = {tan}_{2}^{- 1} ( - {r}_{31} , \sqrt{{r}_{11}^{2} + {r}_{21}^{2}} ) \\ γ = {tan}_{2}^{- 1} ( {r}_{32} , {r}_{33} )\end{matrix} . \qquad formula ( 7 )$$

Next, in one embodiment of the present invention, the camera height H from the ground can be solved according to following equation (8). Furthermore, through a ground plane equation, an origin of the camera coordinate system (i.e., the camera position) can be projected onto the space plane, and the camera height H from the ground can be obtained by calculating a projection vector length.

$$H = \frac{1}{\sqrt{{a}^{2} + {b}^{2} + {c}^{2}}} . \qquad formula ( 8 )$$

In summary, the method of camera calibration using active laser projection described in the above embodiments of the present invention is to project the laser beams onto the plane in space (e.g., the wall, the floor) to obtain the imaging positions of the laser light spots on the image, and then to calculate the extrinsic parameters of the camera including the multiple degrees of freedom such as the position and the attitude through the intrinsic parameters of the camera and the perspective projection model.

Therefore, compared with the method of camera calibration of the prior art, the method of camera calibration using active laser projection contained in the above embodiments of the present invention has the advantages of low cost, easy to use, high environmental adaptability, and high accuracy. It can be widely used in camera calibration of vehicle imaging systems, mobile robots, and outdoor monitoring equipment.

The above embodiments are only used to illustrate the technical solution of the present invention rather than to limit it. Although the present invention has been described in detail with reference to the preferred embodiments, those skilled in the art will understand that the technical solution of the present invention can be modified or equivalent substitutions may be made without departing from the spirit and scope of the technical solution of the present invention.

What is claimed is:

1. A method of camera calibration using active laser projection, comprising:
providing a camera calibration system, which comprises a camera and a plurality of laser emitters;
operating the camera calibration system to cause the laser emitters to project corresponding plurality of laser light spots on two planes;
obtaining image coordinates of the laser light spots through image processing; and
calculating three-dimensional coordinates of the laser light spots using a pinhole imaging principle according to known intrinsic parameters of the camera and the image coordinates of the laser light spots to obtain multiple degrees of freedom of the camera accordingly.

2. The method of camera calibration using the active laser projection of claim 1, wherein when X and Y coordinates of any laser light spot in a camera coordinate system are known, a Z coordinate is calculated through following formula (1) of a pinhole imaging and similar triangle principle,
$$Z = \frac{Xf}{( u - {c}_{x} ) d} = \frac{Yf}{( v - {c}_{y} ) d} \qquad formula ( 1 )$$
wherein (X, Y, Z) are coordinates of any laser light spot projected on the two planes, and (u, v) are coordinates of the laser light spot on an image plane, and f is a focal length, and d is a pixel size, and (cₓ, c_{y}) are coordinates of an origin of the image plane in a pixel coordinate system, wherein the known intrinsic parameters of the camera are the focal length f and image center coordinates (cₓ, c_{y}).

3. The method of camera calibration using the active laser projection of claim 2, further comprising: calculating an equation of the two planes using the three-dimensional coordinates of the laser light spots.

4. The method of camera calibration using the active laser projection of claim 3, further comprising: obtaining three mutually perpendicular vectors using normal vectors of the two planes.

5. The camera correction method using the active laser projection of claim 1, further comprising: calculating roll, yaw, pitch and a camera height from a ground using the three mutually perpendicular vectors.

6. The method of camera calibration using the active laser projection of claim 3,
wherein it is assumed that a plane equation is following formula (2), and there are n points in total on the plane, and n laser light spots (Xᵢ, Yᵢ,Zᵢ) are put into the following formula (2) and write it in matrix form to obtain following formula (3), wherein i=1, 2, 3, . . . n, and then a least squares method of following formula (4) is used to solve the equation of the two planes,
$$ax + by + cz = 1 \qquad formula ( 2 )$$
$$[ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ] [ \begin{matrix}a \\ b \\ c\end{matrix} ] = [ \begin{matrix}1 \\ 1 \\ ⋮ \\ 1\end{matrix} ] , n \geq 3 \qquad formula ( 3 )$$
$$[ \begin{matrix}a \\ b \\ c\end{matrix} ] = {{( {[ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ]}^{T} [ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ] )}^{- 1} [ \begin{matrix}{X}_{1} & {Y}_{1} & {Z}_{1} \\ {X}_{2} & {Y}_{2} & {Z}_{2} \\ ⋮ & ⋮ & ⋮ \\ {X}_{n} & {Y}_{n} & {Z}_{n}\end{matrix} ]}^{T} [ \begin{matrix}1 \\ 1 \\ ⋮ \\ 1\end{matrix} ] . \qquad formula ( 4 )$$
